(19) United States
(12) Patent Application Publication
(10) Pub. No.: US 2008/0063335 A1
(43) Pub. Date: Mar. 13, 2008

(54) Rolling Bearing Assembly

(76) Inventors: Masaru Deguchi, Nara (JP); Youichi Tsuzaki, Nara (JP); Yoshishige Takeda, Osaka (JP)

Correspondence Address: BIRCH STEWART KOLASCH & BIRCH, PO BOX 747, FALLS CHURCH, VA, 22040-0747, US

(21) Appl. No.: 11/663,650

(22) PCT Filed: Sep. 26, 2005
(86) PCT No.: PCT/JP05/17588

§ 371 Date: Mar. 23, 2007

(30) Foreign Application Priority Data
Sep. 30, 1994 (JP) 2004-286777

(51) Int. Cl. F16C 19/38; F16C 35/04

(52) U.S. Cl. 384/543

(57) ABSTRACT

A rolling bearing assembly 1 includes: a hub shaft 2; a double-row hub bearing 4 disposed on an outer periphery of the hub shaft 2 and possessing first-row rolling elements 19 on an outer side and second-row rolling elements 20 on an inner side; and a spindle bearing S interposed between an axle shaft 5 and the hub shaft 2. The spindle bearing S is located at place outside a range defined between working points K1, k2 of the first-row and second-row rolling elements 19, 20 of the hub bearing 4 with respect to an axial direction of the hub shaft, whereby the whole body of the rolling bearing assembly 1 is increased in rigidity. Thus, the rolling bearing assembly is increased in rigidity as a whole, so as to be able to easily bear a moment load particularly applied to the hub shaft, as well as to ensure the strength of the hub shaft.

### TECHNICAL FIELD

The present invention relates to a rolling bearing assembly principally used in an automotive freewheel hub or the like.

### BACKGROUND ART

A freewheel hub for use in part-time 4WD vehicles adapted for shifting between a 2WD drive mode and a 4WD drive mode, for example, is known as a hub adapted for on/off transmission of a driving force transferred thereto. In a case where the freewheel hub is used, the following merit is offered. Two road wheels serving as driven wheels during travel in the 2WD drive mode do not require the rotation of a driving system (axle shaft, differentials, propeller shaft and the like) and hence, the vehicle may achieve improved fuel efficiency, decreased vibrations and noises, increased durability of driving components, and the like.

The above freewheel hub is provided with a rolling bearing assembly. A rolling bearing assembly disclosed in Japanese Examined Patent Publication No. 2003-507683, for example, includes: a hub shaft possessing a flange for mounting a road wheel and having a coupler member fixed to an outer periphery of an end thereof; a double-row hub bearing mounted to an outer periphery of the hub shaft and possessing first-row rolling elements on an outer side and second-row rolling elements on an inner side; and a spindle bearing interposed between an axle shaft inserted in an inside surface of the hub shaft and the hub shaft.

Unfortunately, however, the above rolling bearing assembly may not be able to obtain a sufficient rigidity as a whole because the rolling bearing assembly is used for assembling the hub shaft to the axle shaft. The hub shaft is a member separate from the axle shaft. When a horizontal (axial) force (horizontal G) applies a moment load to the hub shaft, in particular, it is difficult for the bearing assembly to bear the moment load. What is more, the hub bearing and the spindle bearing are so located as to overlap each other in a radial direction of the hub shaft and hence, the hub shaft has a decreased thickness at an area on which the hub bearing is fitted. As a result, the hub shaft cannot attain a sufficient strength.

In view of the foregoing problem in the prior art, the invention has an object to provide a rolling bearing assembly which is increased in rigidity as a whole so as to be adapted, for bearing the moment load particularly applied to the hub shaft, and which ensures the strength of the hub shaft.

### DISCLOSURE OF THE INVENTION

The invention adopts the following technical measure in order to achieve the above object.

A rolling bearing assembly according to the invention comprises: a hub shaft possessing a flange formed on an outer periphery of one axial end thereof and used for mounting a road wheel, and having a coupler member fixed to an outer periphery of the other axial end thereof; a double-row hub bearing mounted to an outer periphery of the hub shaft and including first-row rolling elements on an outer side and second-row rolling elements on an inner side; and a spindle bearing interposed between an axle shaft inserted in an inside surface of the hub shaft and the hub shaft, and is located at place outside a range defined between a working point of the first-row rolling elements of the hub bearing and a working point of the second-row rolling elements with respect to the axial direction of the hub shaft.

According to the rolling bearing assembly of the invention, the spindle bearing is located at place outside the range defined between the working points of the first-row and second-row rolling elements of the hub bearing with respect to the axial direction of the hub shaft, so that an axial distance between the hub bearing and the spindle bearing is increased. Thus, the whole body of the rolling bearing assembly may be increased in rigidity. This makes it easier for the bearing assembly to bear the moment load applied to the hub shaft. What is more, the hub bearing and the spindle bearing are so located as not to overlap each other in the radial direction of the hub shaft. Therefore, the hub shaft is not decreased in thickness at the area on which the hub bearing is fitted. Accordingly, the hub shaft may attain a sufficient strength.

It is further preferred in the above invention that the spindle bearing comprises: a first spindle bearing located on the outer side from the working point of the first-row rolling elements; and a second spindle bearing located on the inner side from the working point of the second-row rolling elements.

In this case, the axle shaft inserted in the hub shaft is carried by the first spindle bearing and the second spindle bearing which define an increased axial distance therebetween. Accordingly, the rolling bearing assembly may achieve an even greater rigidity as a whole. This makes it further easier for the bearing assembly to bear the moment load applied to the hub shaft.

### BRIEF DESCRIPTION OF THE DRAWING

FIG. 1 is a sectional view showing a rolling bearing assembly according to an embodiment of the invention.

### BEST MODE FOR CARRYING OUT THE INVENTION

One embodiment of the invention will be described as below with reference to the accompanying drawing.

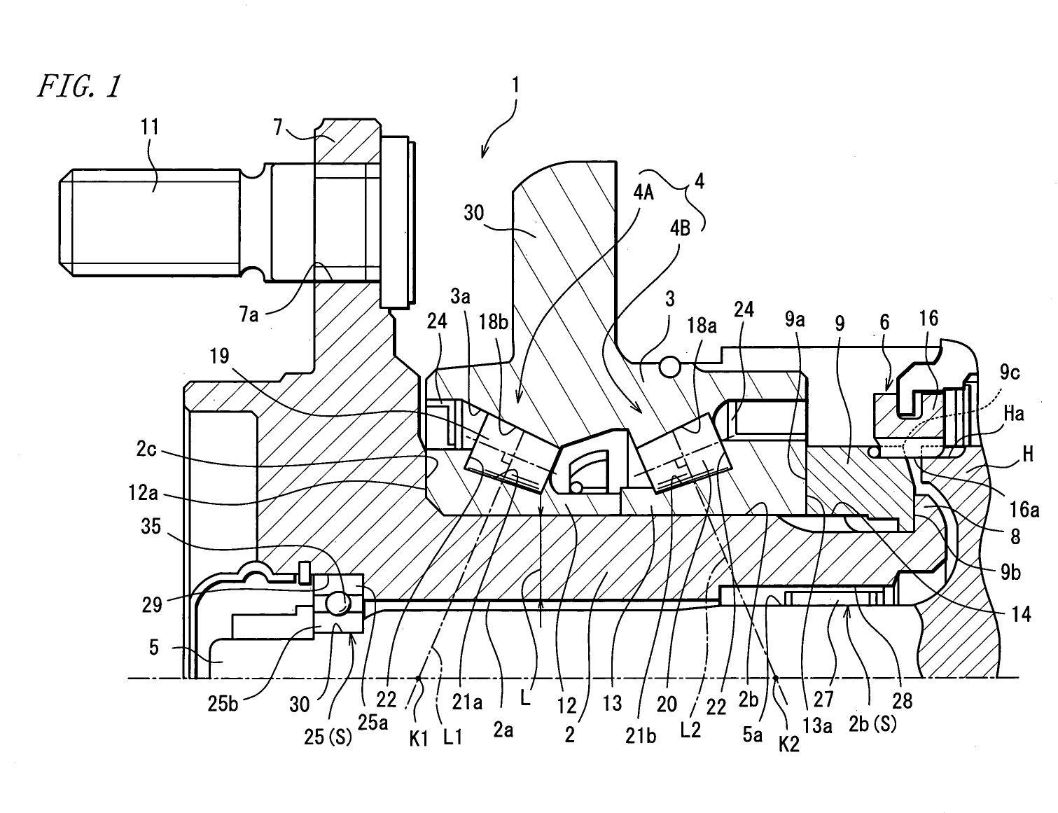

As shown in FIG. 1, a rolling bearing assembly 1 according to the embodiment includes: a hub shaft 2 substantially of a cylindrical shape; a double-row hub bearing 4 (tapered roller bearing) mounted on an outer periphery of the hub shaft 2; and a spindle bearing S interposed between an axle shaft 5 disposed in an inside surface of the hub shaft 2 and the hub shaft 2. The hub shaft 2 is mounted with a road wheel. An outer ring 3 of the hub bearing 4 is fixed to a suspension and the like by way of a flange 30 integrally formed with the outer ring 3. An axis of the hub shaft 2 is aligned with an axis of the axle shaft 5.

The hub shaft 2 is integrally formed with a flange 7 for mounting the road wheel at one end thereof, which is on an outer side with respect to a vehicle (the left-hand side as seen in FIG. 1 and hereinafter, simply referred to as the outer side, and the opposite side thereto will be simply referred to as an inner side). The hub shaft 2 extends from a central area of the flange 7 toward the inner side. On the other hand, the axle shaft 5 is inserted in the inside surface of the hub shaft 2. The flange 7 is formed with bolt holes 7a which are circumferentially arranged at a predetermined pitch. The bolt hole 7a is in threaded engagement with a bolt 11 for fastening a brake rotor, the road wheel or the like to the hub shaft 2.

A first and a second inner ring 12, 13 (to be described hereinlater) of the hub bearing 4 are fitted on an outside surface 2b of the hub shaft 2, so that the hub shaft 2 along with the road wheel fixed to the flange 7 are carried in a manner to be free to rotate relative to the outer ring 3. The hub shaft 2 is formed with a mounting portion 14 at the outer periphery of the other end thereof, which is on the inner side. A coupler member 9 is mounted to the mounting portion 14 in a non-rotatable manner. The hub shaft 2 is further formed with a caulking portion 8 at the inner-side end thereof. An outer end-surface 9b of the coupler member 9 is caulked by the caulking portion 8.

The above axle shaft 5 is integrated with an axle body H at its portion near the coupler member 9. An outer periphery of the axle body H is formed with an axle-side spline Ha having the same diameter and configuration as those of an outer-peripheral spline 9c of the coupler member 9. The outer-peripheral spline 9c is in a coaxial relation with the axle-side spline Ha. The axle-side spline Ha and the outer-peripheral spline 9c are meshed with an inner-peripheral spline 16a of a gear ring 16 slidably movable in an axial direction. When the gear ring 16 moved to one axial end, the gear ring is meshed with both of the axle-side spline Ha and the outer-peripheral spline 9c, whereby a driving force of the axle body H is transmitted to the hub shaft 2. When the gear ring 16 is moved to the other axial end, on the other hand, the gear ring 16 is meshed with the axle-side spline Ha but not with the outer-peripheral spline 9c. In this manner, the gear ring 16 is slidably moved in the axial directions, thereby providing on/off transmission of the driving force to the hub shaft 2. The sliding movement of the gear ring 16 is effected by means of a sliding movement mechanism using suitable power means such as air or hydraulic pressure.

The hub bearing 4 is constituted as a double-row outwardly-tapered roller bearing. The hub bearing is used for rotatably carrying the hub shaft 2 relative to a vehicular suspension apparatus and for receiving great radial load, axial load and moment load applied from a vehicle body. The hub bearing 4 includes: a single outer ring 3 possessing two outer races 18a, 18b adjoining each other in the axial direction of the hub shaft; first-row tapered rollers 19 (rolling elements.) on the outer side and second-row tapered rollers 20 (rolling elements) on the inner side, which are arranged on the above two outer races 18a, 18b; the first inner ring 12 possessing an inner race 21a on the outer side; and the second inner ring 13 possessing an inner race 21b on the inner side.

The first inner ring 12 has its outer end surface 12a abutted against a corner portion 2c of the hub shaft 2, whereas the second inner ring 13 has its outer end surface 13a abutted against an inner end surface 9a of the coupler member 9. Thus, the first and second inner rings 12, 13 and the coupler member 9 are fixed in space defined between the corner portion 2c and the caulking portion 8, so as to be prevented from moving in the axial direction of the hub shaft. Accordingly, the inner rings 12, 13 and the coupler member 9 are rotated unitarily with the hub shaft 2.

The inner-side outer race 18a of the outer ring 3 is tapered as progressively increased in diameter toward the inner-side end of the hub shaft 2. The outer-side outer race 18b of the outer ring is tapered as progressively increased in diameter toward an outer-side end of the hub shaft 2. On the other hand, the inner race 21a of the first inner ring 12 is tapered as progressively increased in diameter toward the inner-side end of the hub shaft 2. The inner race 21b of the second inner ring 13 is tapered as progressively increased in diameter toward the outer-side end of the hub shaft 2. The first and second inner rings 12, 13 are formed with a jaw on the outer side thereof and the inner side thereof, respectively. Respective race portions of the first and second inner rings 12, 13 are defined by the respective tapered inner races 21a, 21b and respective inside walls 22 of the jaws. Seal portions 24 are mounted to axially opposite ends of the tapered roller bearing pair, such as to seal individual annular openings defined between the inner ring and the outer ring.

The spindle bearing S for rotatably carrying the axle shaft 5 relative to the hub shaft 2 includes: a deep groove ball bearing 25 (first spindle bearing) disposed on the outer side; and a needle roller bearing 26 (second spindle bearing) disposed on the inner side. Needle rollers 27 as rolling elements of the needle roller bearing 26 are arranged on races defined by a great-diameter surface 28 formed at the inner-side end of the hub shaft 2 and defined by an outer periphery 5a of the axle shaft 5. The deep groove ball bearing 25 is mounted by fitting an outer ring 25a thereof fitted in a step 29 formed in an inside surface of the outer-side end of the hub shaft 2. This deep groove ball bearing 25 has its inner ring 25b fitted in a step 30 formed at an end of the axle shaft 5. In this manner, the axle shaft 5 is rotatably carried in the inside surface of the hub shaft 2. The reason for employing the needle roller bearing 26 as the second spindle bearing is to avoid the decrease of thickness L of the hub shaft 2.

As shown in FIG. 1, the above hub bearing 4 is provided in a required range covering a substantially central portion of the hub shaft in the axial direction thereof. The deep groove ball bearing 25 of the above spindle bearing S is disposed at place shifted toward the outer side from a working point K1 of the first tapered rollers 19 of the hub bearing 4 (tapered roller bearing) with respect to the axial direction of the hub shaft. On the other hand, the needle roller bearing 26 is disposed at place shifted toward the inner side from a working point K2 of the second tapered rollers 20 with respect to the axial direction of the hub shaft. Thus, the deep groove ball bearing 25 and the needle roller bearing 26 (the spindle bearings) are disposed at places outside the range defined between the working points K1, K2.

The term “working point K1, K2”, as used herein, means an intersection of a line L1 (line of action) passing through a midpoint of an axis of the tapered roller 19 and orthogonal to this axis and an axis of the hub shaft 2 (or an axis of the deep groove ball bearing 25 or of the needle roller bearing 26), as seen in the sectional view of FIG. 1. That the deep groove ball bearing 25 is located on the outer side from the working point K1 of the first tapered rollers 19 (outside the range defined between the above working points K1, k2) as stated herein, means that the deep groove ball bearing 25 does not overlap on the above working point K1, or more preferably does not overlap on the above line of action L1. That the needle roller bearing 26 is located on the inner side from the working point K2 of the second tapered rolling elements 20 (outside the range defined between the above working points K1, k2), as stated herein, means that the needle roller bearing 26 does not overlap on the above working point K2 or more preferably does not overlap on the above line of action L2.

In this manner, the tapered roller bearing 4 and the needle roller bearing 26 (spindle bearing S) are located outside the range defined between the working points K1, K2 of the first and second rolling elements (so disposed as not to be present in the above range). Therefore, an axial distance between the hub bearing 4 and the spindle bearing S is increased so that the whole body of the rolling bearing assembly is increased in rigidity. This makes it easy for the rolling bearing assembly to bear the moment load applied to the hub shaft 2. Furthermore, the rolling bearing assembly as a whole may be further increased in rigidity because the axle shaft inserted in the inside surface of the hub shaft is carried by the above tapered roller bearing 4 and the needle roller bearing 26 which define the increased axial distance therebetween. This makes it much easier for the rolling bearing assembly to bear the moment load applied to the hub shaft.

In addition, the hub bearing 4 and the spindle bearing S do not overlap each other in the radial direction of the hub shaft. Therefore, the hub shaft 2 is not decreased in the thickness L at the area thereof, on which the hub bearing 4 is fitted. This ensures the strength of the hub shaft 2. It is noted that the foregoing embodiment is described for purposes of illustration and not limitation. That is, the hub bearing 4 or the spindle bearing S may also be constituted by another bearing. For example, the needle roller bearing 26 of the spindle bearing S may be constituted by a deep groove ball bearing.

What is claimed is:

1. A rolling bearing assembly comprising:
a hub shaft possessing a flange formed on an outer periphery of one axial end thereof and used for mounting a road wheel, and having a coupler member fixed to an outer periphery of the other axial end thereof;
a double-row hub bearing mounted to an outer periphery of the hub shaft and including first-row rolling elements on an outer side and second-row rolling elements on an inner side; and
a spindle bearing interposed between an axle shaft inserted in an inside surface of the hub shaft and the hub shaft, and is located at place outside a range defined between a working point of the first-row rolling elements of the hub bearing and a working point of the second-row rolling elements with respect to the axial direction of the hub shaft.

2. A rolling bearing assembly according to claim 1, wherein the spindle bearing comprises: a first spindle bearing located on the outer side from the working point of the first-row rolling elements; and a second spindle bearing located on the inner side from the working point of the second-row rolling elements.
